(19) United States
(12) Patent Application Publication
(10) Pub. No.: US 2010/0058549 A1
(43) Pub. Date: Mar. 11, 2010

(54) Velvety laminar strip cleaning element for making rotary making brushes for motor vehicle washing systems

(76) Inventor: Francesco Favagrossa, Roncadello Di Casalmag (IT)

Correspondence Address: HEDMAN & COSTIGAN P.C., 1185 AVENUE OF THE AMERICAS, NEW YORK, NY, 10036, US

(21) Appl. No.: 12/310,738

(22) PCT Filed: Jul. 4, 2007
(86) PCT No.: PCT/IT2007/000481

§ 371 Date: Oct. 15, 2009

(30) Foreign Application Priority Data
Sep. 12, 2006 (IT) MI2006A001742

(51) Int. Cl. B60S 3/06

(52) U.S. Cl. 15/97.3

(57) ABSTRACT

An improved cleaning element, specifically designed for rotary brushes for motor vehicle washing systems, is made by using components of a velvety material which is suitably flocked by either a direct process or by coupling with velvety materials or velvets.

### BACKGROUND OF THE INVENTION

The present invention relates to a velvety laminar strip cleaning element for making rotary brushes for motor vehicle washing systems.

As is known, automatic motor vehicle washing systems conventionally comprise rotary washing brushes, which generally include a supporting element, having a cylindric configuration, coupled to a rotary element.

On an outer surface of the supporting element, a plurality of flexible cleaning elements, joined to one another and coupled at an end portion thereof to the supporting element, perpendicularly to the latter, are provided.

The automatic cleaning and washing, for example of a car body, are performed by causing a plurality of the above disclosed type of brushes to turn, thereby causing in turn the flexible elements of the brushes, held at a preset configuration thereof under the centrifugal force generated by the rotary movement of the brushes, the delicately touch the car body, through the interposition of water and/or suitable washing emulsions or solutions.

Prior washing brushes, or movable washing curtains, conventionally included cleaning strips or bands, generally made of a felt material, or synthetic material bristles, or foamed synthetic material strips.

A felt material, as is known, is a water absorption product, adapted to hold dirt particles removed from the paint of the motor vehicle being washed, which holding, however, is undesirable for a proper preservation of the motor vehicle painted surfaces.

Actually, extruded bristles, independently from their shape (a star, cross, flat or round configuration) usually leave signs of their passage, since they self-deposit on the motor vehicle painted surfaces.

The foamed synthetic material, on the other hand, has a very good performance with respect to the preservation of the painted surface, but it has the disadvantage that its weight is very light and, accordingly, it is not as efficient, in removing dirt, as it would be desirable.

Each of the above mentioned types of brushes, requires a different mechanical and electronical set-up of the washing machine, since different is the construction and weight of the rotary material washing brushes.

### SUMMARY OF THE INVENTION

Thus, the aim of the present invention is to provide an improved cleaning element, specifically designed for rotary washing brushes to be used in motor vehicle washing systems or machines, which is adapted to overcome the above mentioned drawbacks affecting the prior art.

Within the scope of the above mentioned aim, a main object of the invention is to provide such an improved laminar strip velvety cleaning element, allowing to perfectly preserve the starting characteristics and operating parameters, for which the washing machines have been pre-calibrated, and specifically adapted to provide an efficient velvety structure between the surface to be washed and the cleaning elements of the rotary brushes affecting said surface.

Another object of the present invention is to provide such a laminar strip cleaning element, having a velvety surface adapted to remove the dirt particles from the motor vehicle body, without restraining said particles, thereby providing a satisfactory washing force or effect.

Yet another object of the present invention is to provide such a velvety strip cleaning element which has a very high operating efficiency, and which does not leave any evident signs of its passage through the painted surfaces of the motor vehicles being washed.

Yet another object of the present invention is to provide such a velvety strip cleaning element which is adapted to reduce the so-called “floating” problem on the motor vehicle surface, without sinking into the water layer being projected on the painted surface, during the washing operations.

According to one aspect of the present invention, the above mentioned aim and objects, as well as yet other, objects, which will become more apparent hereinafter, are achieved by a velvety strip cleaning element, specifically designed for rotary washing brushes for motor vehicle washing systems, characterized in that said cleaning element comprises a strip body, made of a felt material, a foamed plastic material, a non-woven fabric material, or a cloth material, being flocked either by a direct flocking process or by coupling it to velvety materials, after having applied a suitable adhesive plastic material to said element.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative example, in the accompanying drawings, where:

FIG. 1 is a top plan view of a strip cleaning element, comprising a laminar body made of a felt material, a foamed plastics material, a fabric or cloth material, as suitably processed by a resin material and flocked, according to the invention;

FIG. 2 is a partial cross-sectional view of the subject cleaning element, being cut into strips;

FIG. 3 is a further top plan view, as, partially cross-sectioned, showing the components of the cleaning element;

FIG. 4 is a further cross-sectioned partial view of the components shown in FIG. 3;

FIG. 5 is a further top plan view, in a partially exploded form, of the plate-like body covered by a covering resin to provide the cleaning element according to the present invention;

FIG. 6 is a top plan view of a band element designed to be applied to a rotary brush, made starting from the plate-like strip cleaning element according to the present invention;

FIG. 7 is a top plan view of a web strip band, similar to that of FIG. 6, but in which the flocked pattern does not extend up to the bottom;

FIG. 8 shows a further inclined or slanted strip band, made by the strip, resin processed and flocked, cleaning element according to the present invention;

FIG. 9 shows a composite-construction band element, including a strip, resin processed and flocked cleaning element according to the present invention;

FIG. 10 is a partial perspective view showing a cleaning brush including a plurality of composite construction strip band elements;

FIG. 11 is a cross-sectioned elevation view of a cleaning brush including a plurality of velvety strip band elements;

FIG. 12 is a cross-sectioned side view showing the velvety strip brush of FIG. 11;

FIG. 13 is a partial perspective view showing a latching or locking system for latching or locking the band elements to a central support of a washing brush;

FIG. 14 is a schematic elevation view showing a washing brush including a plurality of resin processed, velvety strip band elements according to the present invention; and

FIG. 15 is a further elevation view schematically showing the cleaning action provided on a motor vehicle by rotary cleaning brushes, including resin processed and velvety strip elements made according to the present invention.

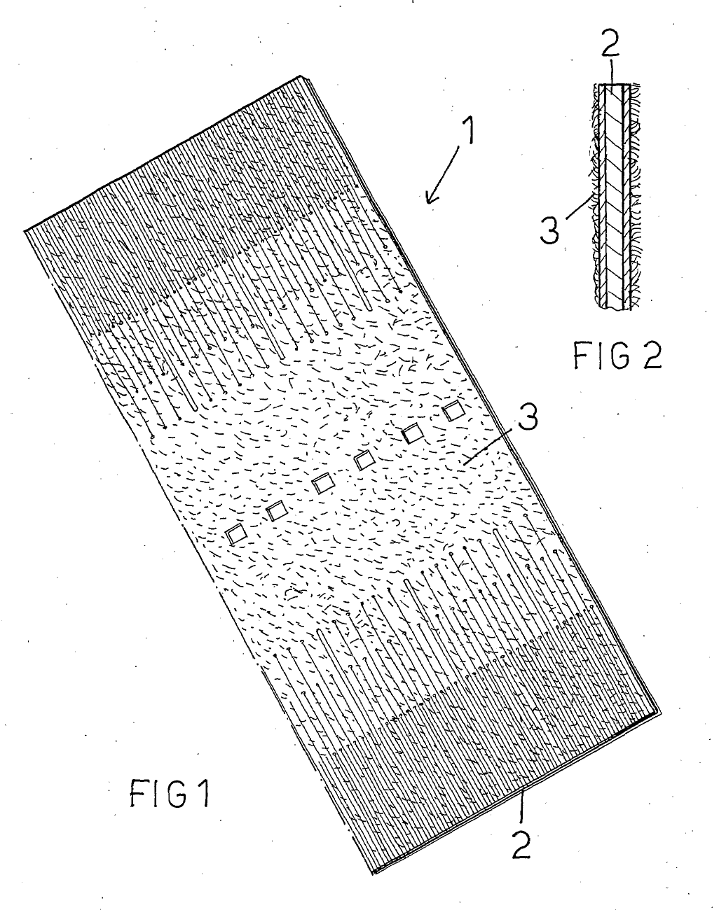

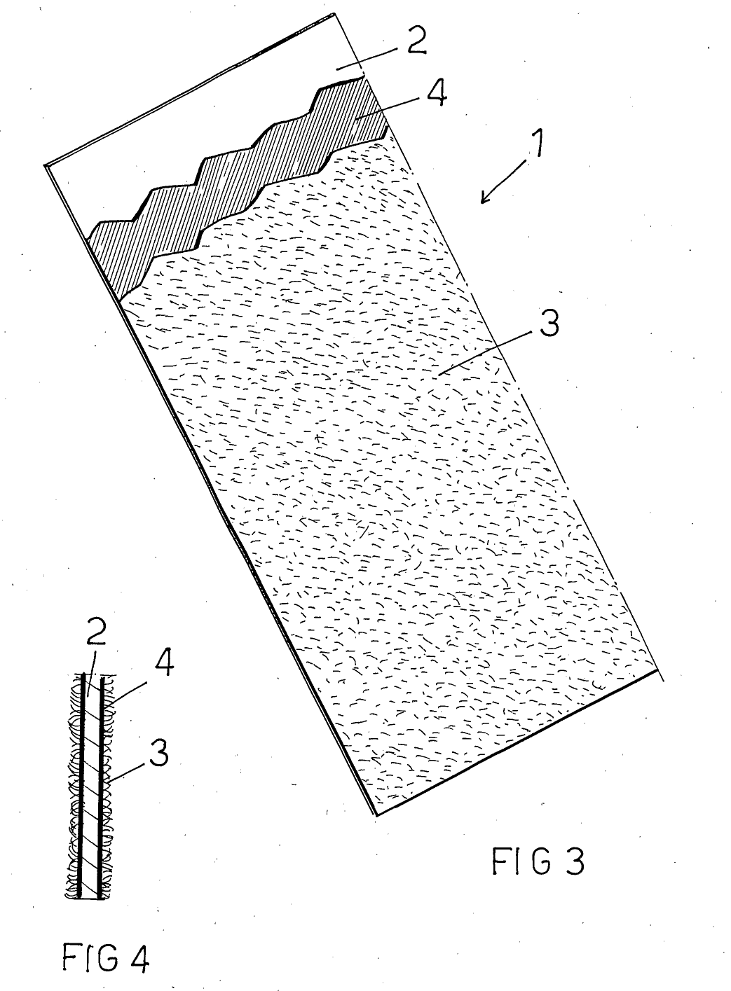

### DESCRIPTION OF THE PREFERRED EMBODIMENTS

With reference to the number references of the above mentioned figures, the cleaning strip element according to the present invention, which has been generally indicated by the reference number 1, comprises a plate-like body 2, which can be advantageously made of a closed cell foamed plastics material, a felt material, a cloth material, a foamed plastic material, a fabric material or any other suitable materials.

According to the present invention, the strip or web body 2 is provided, by processing it by a suitable resin adhesive material, with a velvety fabric layer 3, preferably by a coupling method.

Alternatively, that same plate-like body is divided into a plurality of component strips, resin processed by an adhesive material layer and subjected to a velveting process, by causing fibers, the so-called “flock”, to adhere to the plate-like material.

Actually, a flocking process, as it is well known, consists of a velveting process or system, causing very short fibers, called “flocks”, having a length of the order of some tens of millimeters to few millimeters, to adhere to a supporting element.

More specifically, said fibers are electrostatically charged to be deposited on the supporting element, connected to ground, thereby firmly adhering to said supporting element by further applying a synthetic resin based adhesive material 4.

More specifically, the body 2 forming the support of the cleaning element, can comprise a synthetic foamed material, a natural or synthetic felt material, a natural or synthetic fiber cloth material, or a non-woven fabric material.

In particular, if the body or support is made of the felt material, then the flocking process will provide a surface thereof resistant against dirt particles, while the microfibers held therein will enhance its washing force.

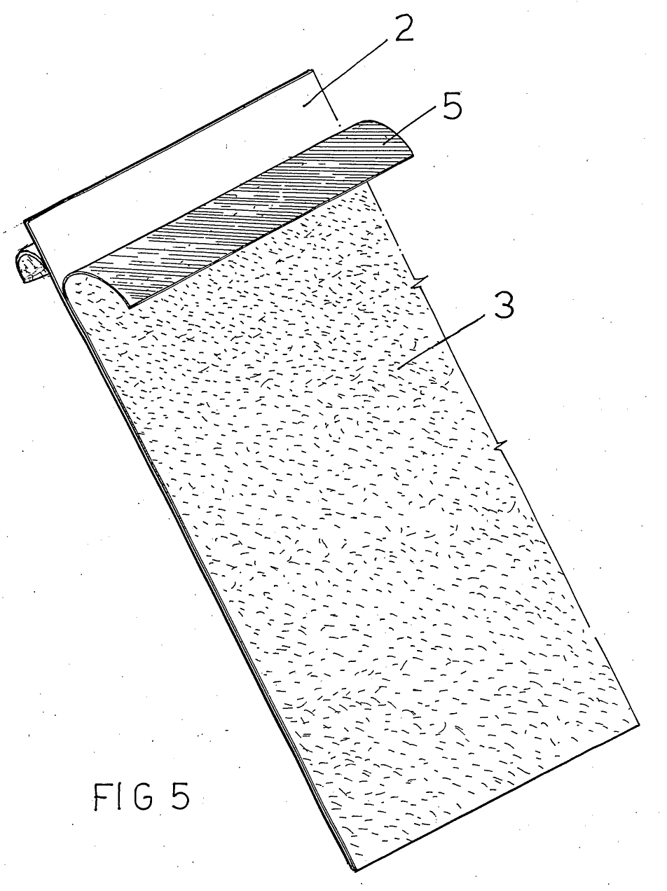

Moreover, said cleaning element 1 can also comprise a bottom or base body 2, covered by a velvety material layer 5, as is schematically shown in FIG. 5.

On the other hand, if said body is made of a synthetic foamed material, then the efficiency of the cleaning element will be greatly enhanced, which cleaning element, on the other hand, would tend to “float” on the motor vehicle being washed, and it will not be sufficiently immersed into the water layer sprayed on the motor vehicle painted surface, during the washing operation.

According to the present invention, the material used for the support element 2, the resin layer 3 coating it, may have any desired thickness, adapted to provide the required adhering and waterproofing properties.

If the support element is made of a synthetic foamed material, then the amount of resin or plastics material to be used will be that which is strictly necessary for allowing the flocked layer to be properly adhered, since it would not be necessary to waterproof the laminar or plate-like support.

On the other hand, if said laminar support 2 is made of a felt material, a cloth or non woven fabric material, or a water absorbing material, then the resin or plastic layer will be adjusted depending on the desired waterproofing properties to be achieved.

Such a waterproofing will be preferably a full waterproofing on the bottom of the strip band elements, whilst it would be preferable that the outer end portion have a given water absorption property, to improve the cleaning action thereof.

The thus made resin processed and velveted strip laminar cleaning element 1 will allow to make band elements of several different configurations, to provide rotary washing brushes adapted to be used in automatic motor vehicle washing systems and in manual motor vehicle washing equipments.

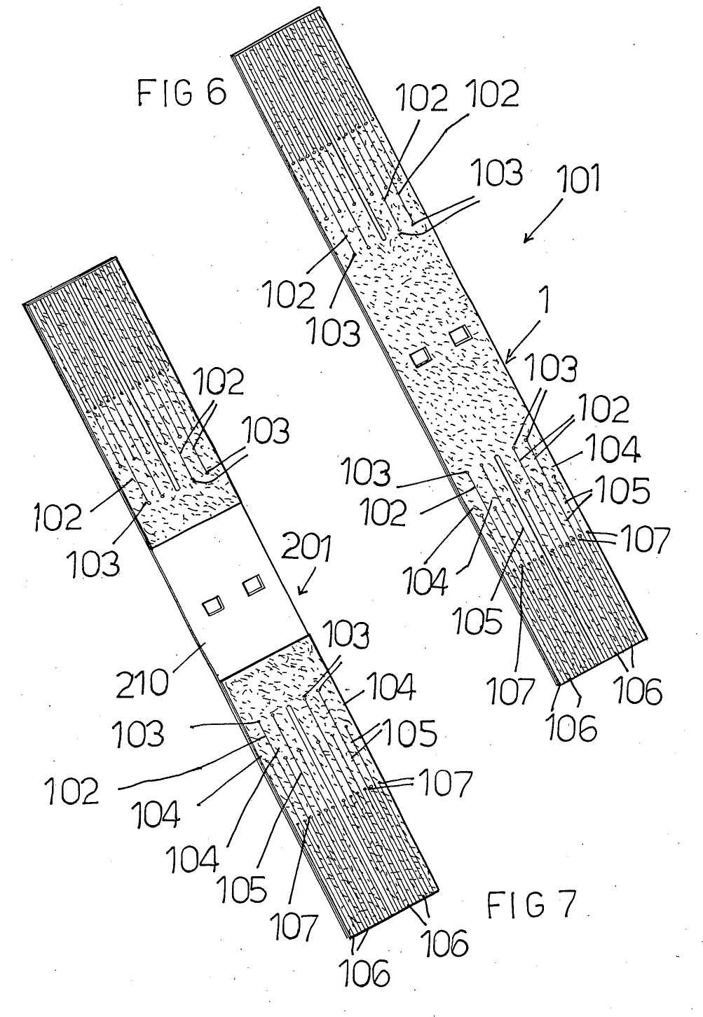

FIG. 6 shows a band element 101 comprising a cleaning strip element 1 including, on opposite sides thereof with respect to its cross middle line, central cuts 102, extending from anti-tearing enlarged regions 103.

The latter will practically define discrete or separated sectors 104, which will be provided with further or second cuts 105, to form a plurality of strips 106, extending in parallel with respect to one another and, furthermore, in parallel with respect to the central cuts 102.

The second cuts 105 also extend starting from anti-tearing enlarged portions 107.

The band element 101 can be bent or folded through 180° about the longitudinal axis thereof, to allow the sectors 104 to be mutually overlapped.

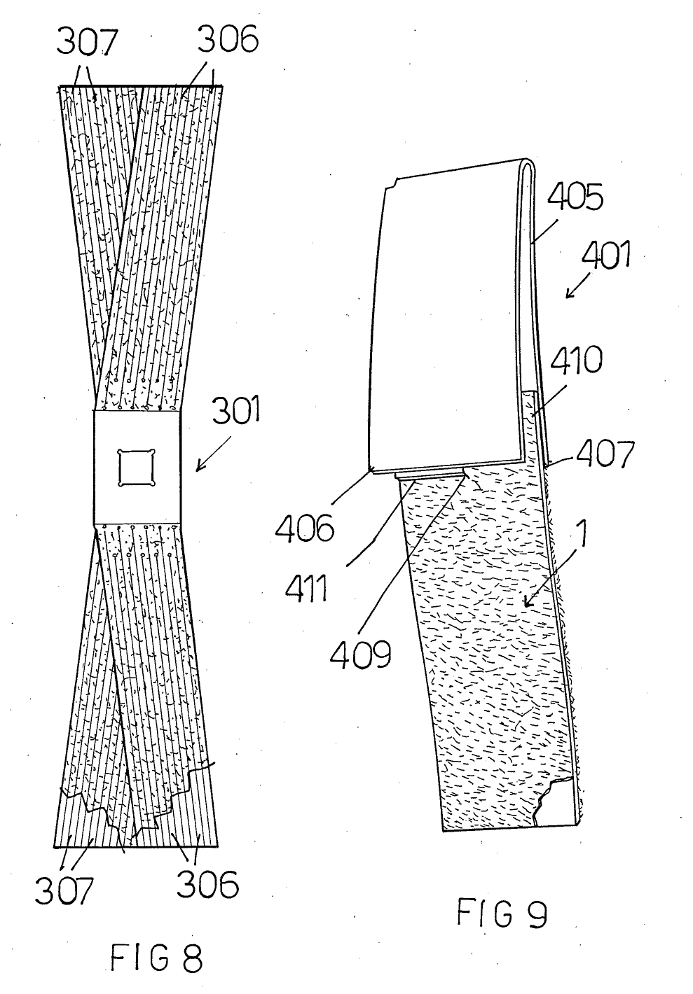

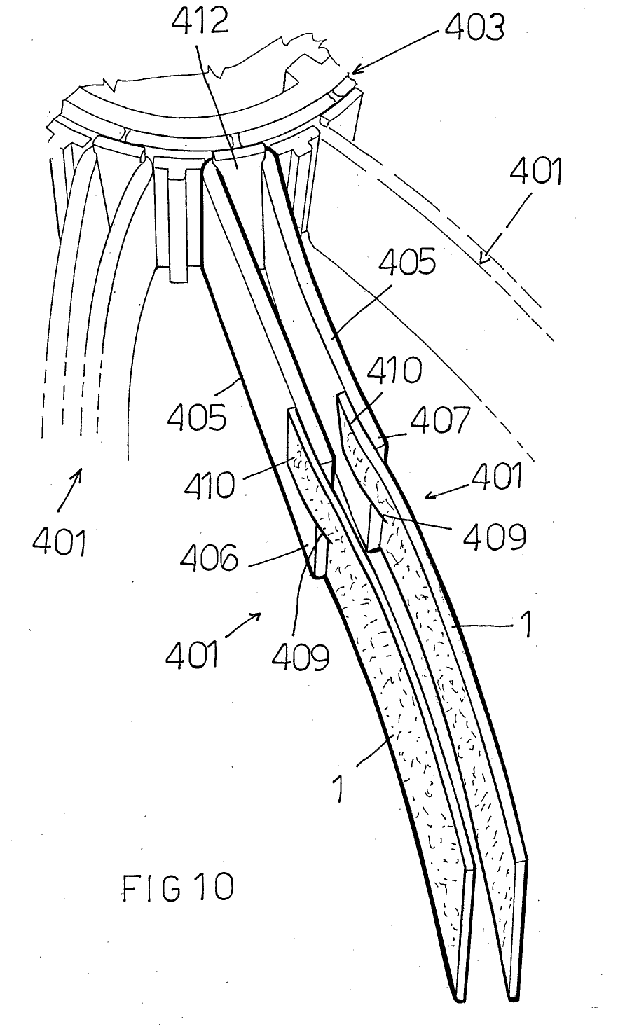

The band element 201 shown in FIG. 7 is substantially similar to the band element 101, as thereinabove disclosed, with the exception that its central portion 210 has not been subjected to a velveting treatment.

As is shown in FIG. 8, the band element, herein indicated by the reference number 301, is made as above disclosed and, moreover, can also be constructed in such a manner that, after overlapping onto one another, said sectors would provide strip elements 306 and 307 having opposite slanted patterns.

Such an approach would allow to make rotary washing brushes, by coupling the mentioned band elements to a central supporting shaft, and having an enhanced washing useful width, with respect to straight band element washing brushes.

FIG. 9 shows a band element 401, of a composite construction, made starting from a cleaning element 1, associated with a plate 405 made of a relatively stiff material.

More specifically, said plate 405 is bent or folded through 180°, thereby providing two free end portions 406 and 407 and a folded region to be affixed to the central support 403 of the rotary washing brush.

The cleaning element 1 is coupled to the end portions 406 and 407 of said plate 405 either by a stitching, seaming or glueing method.

Preferably, the cleaning element 1 comprises, at the end portion thereof to be coupled to the corresponding end portion of the plate, a notch or cut-out 409 dividing said end portion into a first flap 410 and a second flap 411.

Thus, it is possible to associate the first flap 410 to a side of the end portion of the plate, and the second flap 411 to other side of the plate end portion, to provide a very firm and safe connection between the plate 405 and the two respective mentioned cleaning elements 1.

In particular, the connection of the band element 401 to the central support 403 is made by coupling means comprising a clamping bar 412 which is engaged in a respective engagement slot of a plurality of slots formed along the directrix line of the central support 403.

After the connection, the end portion of the bar or rod 412 will tightly and safely contact the support 403, thereby allowing it to be safety welded or sealed.

Thus, the connection means according to the present invention allow to perform the coupling without the need of using specifically designed coupling tools, thereby allowing to greatly reduce the physical effort to a minimum.

The small bar or rod 412 will operate to hold the band element 401 clamped to the cylinder 403.

The width of the small bar or rod 412, in particular, will be designed to provide a plurality of equispaced slots.

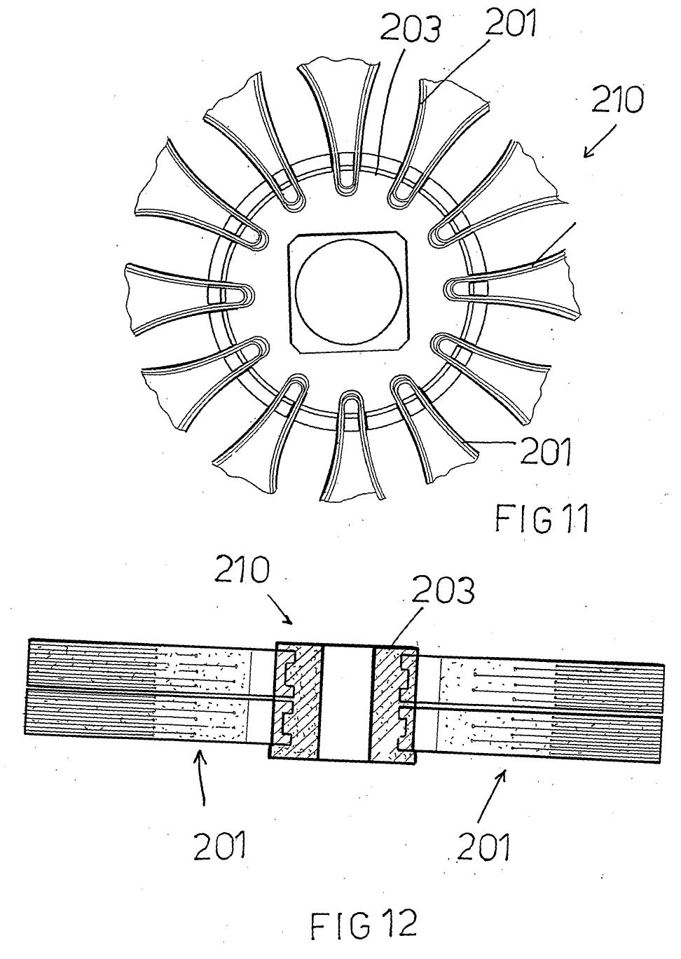

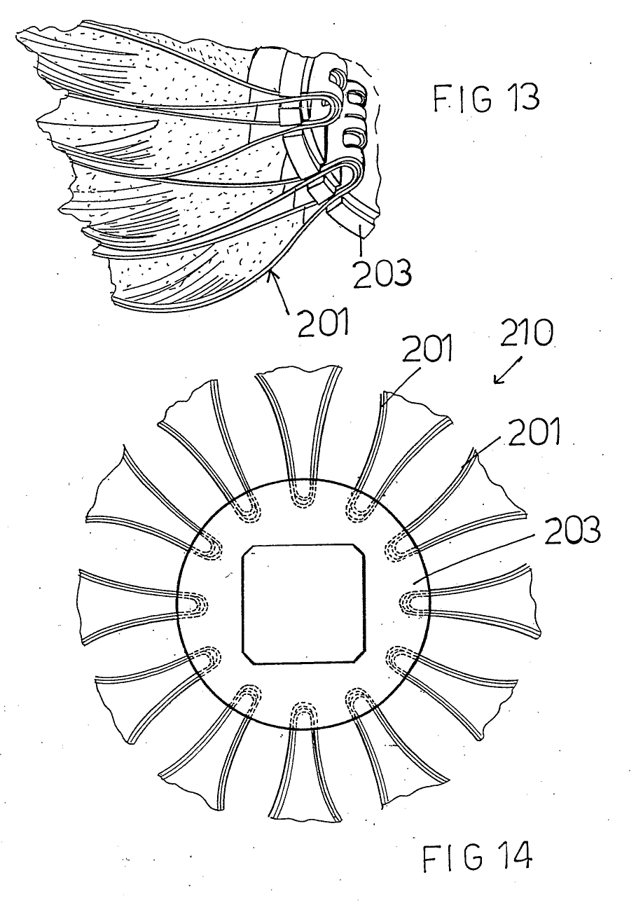

FIGS. 11-14 show an exemplary embodiment of a rotary washing brush, generally indicated by the reference number 210, made by coupling a plurality of band elements 201 to a central support 203.

The velvety rotary washing brushes made as above disclosed can be used either in automatic or in manual motor vehicle washing systems.

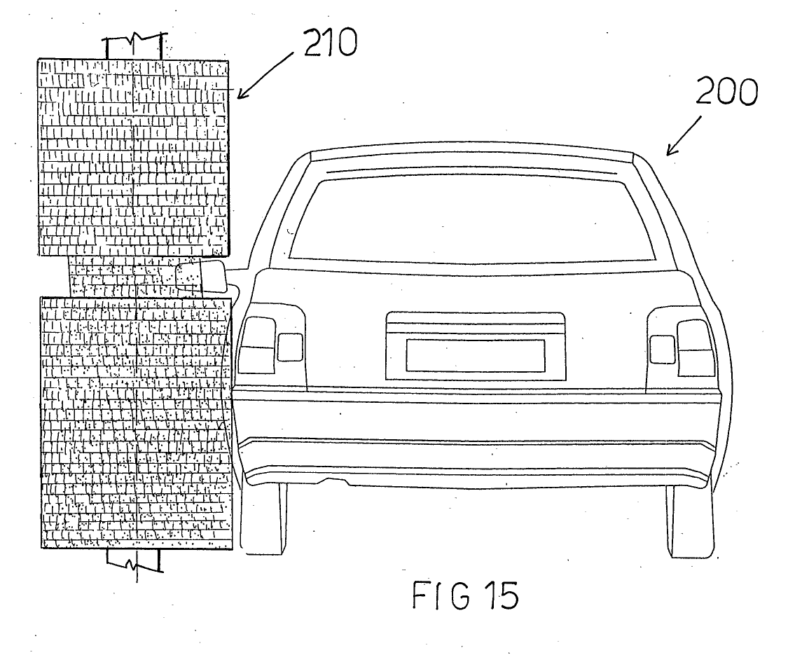

FIG. 15 schematically shows an assembly or set of rotary brushes 201, including a plurality of laminar velvety strips, which can be used for washing a motor vehicle 200.

It has been found that the invention fully achieves the intended aim and objects.

In fact, the invention provides an improved velvety strip laminar element which is specifically adapted to hold constant the starting characteristics and operating parameters, for which the washing system has been precalibrated, thereby providing an efficient velvety protective arrangement between the surface to be washed and the cleaning elements of the rotary washing brushes operating thereon.

1. An improved strip cleaning element, specifically designed for rotary washing brushes for motor vehicle washing systems, characterized in that said cleaning element comprises a laminar body made of a material which has been flocked either by a direct flocking method or by coupling it to a velvety material layer.

2. An improved strip cleaning element, according to claim 1, characterized in that said laminar body comprises either a natural or a synthetic felt material.

3. An improved strip cleaning element, according to claim 1, characterized in that said laminar body comprises a plastic foamed material.

4. An improved strip cleaning element, according to claim 1, characterized in that said laminar body comprises a natural or synthetic fiber cloth material.

5. An improved strip cleaning element, according to claim 1, characterized in that said laminar body comprises a non-woven fabric material.

6. An improved strip cleaning element, according to claim 1, characterized in that said cleaning element comprises a laminar base body, covered by a velvety material layer, said velvety material layer being coupled by an adhesive material.

7. An improved strip cleaning element, according to claim 1, characterized in that the adhesive resin layer coating said cleaning element has a thickness providing said element with variable waterproofing characteristics.

8. An improved strip cleaning element, according to claim 1, characterized in that, if said support is made of a plastic foamed material, then the amount of plastic material to be used would be that which would be strictly necessary to provide a glueing of the flocked layer, since it would not be necessary to waterproof the support.

9. An improved strip cleaning element, according to claim 1, characterized in that, if the support is made of a felt material, a cloth or non woven fabric material, or a water absorbing material, then said resin or plastic material layer is so adjusted as to provide a desired waterproofing property.

10. An improved strip cleaning element, according to claim 1, characterized in that said waterproofing is preferably a full waterproofing on the bottom of the band elements, whilst it would be preferable that the end portions would have a given water absorption property to improve the cleaning effect.

11. An improved strip cleaning element, according to claim 1, characterized in that said cleaning element allows to make laminar band elements of several shapes and configurations, for making rotary washing brushes to be used in automatic motor vehicle washing systems and in manual motor vehicle washing equipments.

12. A strip band element, for rotary brushes for motor vehicle washing systems, according to claim 1, characterized in that said band element comprises said cleaning element having, on opposite sides of a middle line thereof, central cuts, extending from anti-tearing enlarged portions delimiting separated sectors provided with second cuts, to provide in turn a plurality of velvety strip elements extending parallel to one another and in parallel to the central cuts, the second cuts also extending from anti-tearing enlarged portion, said band element being adapted to be folded through 180° about the longitudinal axis thereby allowing said sectors to be mutually overlapped.

13. A strip band element, for rotary brushes for motor vehicle washing systems, according to claim 1, characterized in that said central portions, to be coupled to the brush central support, is not velveted.

14. A strip band element, for rotary brushes for motor vehicle washing systems, according to claim 1, characterized in that said band element is so made that, upon overlapping, said sectors provide velvety strip elements having opposite inclinations.

15. A strip band element, for rotary, brushes for motor vehicle washing systems, according to claim 1, characterized in that said strip band has a composite construction, made starting from a cleaning element coupled to a plate made of a relatively stiff material, said plate being folded through 180° thereby providing two free end portions thereof and a bending region to be clamped to the central support of the rotary washing brush, said velvety cleaning element being coupled to the end portions of said plate by seaming or glueing.

16. A strip band element, according to claim 1, characterized in that said cleaning element is velveted and comprises, at an end portion thereof to be coupled to the end portion of the plate, a cut dividing said end portion into a first flap and a second flap, thereby associating the first flap to a side of the end portion of the plate and the second flap to the other side of said end portion of said plate to provide a firm coupling between said plate and the two respective cleaning elements.

17. A strip band element, according to claim 1, characterized in that said velvety band element is coupled to the central support of the washing brush by coupling means comprising a clamping bar engaged in a respective slot of a plurality of slots formed along directrix line of said central support, wherein, after connection, the end portion of said bar element tightly contact the support to allow said support to be safely welded.

18. A strip band element, according to claim 17, characterized in that said coupling means provides a coupling without the need of using specifically designed coupling tools and allow to reduce the physical effort to a minimum.

19. A strip band element, according to claim 17, characterized in that said bar element, for holding said velvety band element clamped to the support has such a width as to allow to provide a plurality of equispaced slots.

20. A rotary brush, specifically designed for motor vehicle washing systems, characterized in that said rotary brush is made by coupling a plurality of strip velvety band elements according to claim 1, to a central support.
